(19) United States
(12) Patent Application Publication
(10) Pub. No.: US 2024/0266103 A1
(43) Pub. Date: Aug. 8, 2024

(54) MAGNETIC COMPONENT

(71) Applicants: KABUSHIKI KAISHA TOSHIBA, Tokyo (JP); TOSHIBA MATERIALS CO., LTD., Yokohama-shi (JP)

(72) Inventors: Tadao SAITO, Yokohama Kanagawa (JP); Satoru HABU, Yokohama Kanagawa (JP); Takahiro MAEDA, Yokohama Kanagawa (JP); Katsuhiko YAMADA, Yokohama Kanagawa (JP)

(73) Assignees: KABUSHIKI KAISHA TOSHIBA, Tokyo (JP); TOSHIBA MATERIALS CO., LTD., Yokohama-shi (JP)

(21) Appl. No.: 18/601,662

(22) Filed: Mar. 11, 2024

Related U.S. Application Data
(63) Continuation of application No. PCT/JP22/26521, filed on Jul. 1, 2022.

(30) Foreign Application Priority Data
Sep. 27, 2021 (JP) 2021-156237

(51) Int. Cl. H01F 27/25

(52) U.S. Cl. CPC H01F 27/25

(57) ABSTRACT

A magnetic component of an embodiment has a resin-made hollow container that houses a doughnut-shaped magnetic core, and the resin forming the hollow container exhibits a white color to gray color having a chromatic value C of 0 (achromatic) to 2 and a lightness V or 8 or higher as defined by JIS Z8721 “Color specification—Specification according to their three attributes”. The hollow container has an inner wall portion formed to form a hollow portion, an outer wall portion formed to surround the inner wall portion, and a bottom portion provided at one end of each of the inner wall portion and the outer wall portion to close a space between the inner wall portion and the outer wall portion, and houses the doughnut-shaped magnetic core between the inner wall portion and the outer wall portion.

### CROSS-REFERENCE TO RELATED APPLICATIONS

This application is a bypass continuation application of International Application No. PCT/JP2022/026521, filed Jul. 1, 2022, which designates the United States, incorporated herein by reference, and which claims the benefit of priority from Japanese Patent Application No. 2021-156237, filed Sep. 27, 2021, the entire contents of which are incorporated herein by reference.

### FIELD

The present embodiments relate to a magnetic component.

### BACKGROUND

Switching power supplies mounted on electronic devices as represented by the Federal Communications Commission (FCC) are restricted for their noise for each class. There are various causes for noise generation in a power supply; however, the noise is generated mainly around a semiconductor element that turns on and off large electric power. In particular, a radio frequency component is propagated through the air as radiation noise, which causes malfunction of various electronic devices. Therefore, a regulation value is set in each frequency band. In switching power supplies, noise countermeasures are taken for semiconductor elements, mainly MOS-FETs and diodes. As a representative example of noise countermeasures for MOS-FETs or diodes, noise countermeasures using a CR snubber or ferrite beads can be mentioned.

The noise countermeasures are used separately depending on effects, cost, and the availability of a mounting space. In a case where the performance is considered in particular, those using Co-based amorphous is the mainstream of noise countermeasures. Since the Co-based amorphous is excellent in magnetic characteristics, the noise reduction effect is superior to that of the ferrite beads. Alternatively, there are cases where a magnetic ribbon made of Fe-based amorphous or Fe-based magnetic alloy having microcrystals is used instead of the Co-based amorphous.

Since a magnetic alloy having amorphous or microcrystals generally exhibits conductivity, it is necessary to store the magnetic alloy in an insulating resin case or to provide exterior insulation such as epoxy coating in a case where a lead or winding is provided. In particular, since a shape difference is likely to occur in a magnetic component beyond a point where a metal ribbon is bent back, which is different from a press-molded product such as ferrite, dimensional variation may occur in epoxy coating, and in a case where a thick cord of about ϕ1 to ϕ2 mm is wound around a magnetic component, an insulating resin case is generally used from the viewpoint of resistance to stress.

In a case where a noise suppression element is incorporated in an electric circuit such as a power supply, the noise suppression element may be used in a high-temperature environment for a long time due to heat generation in the circuit. In this case, the magnetic characteristics of the noise suppression element are deteriorated, and the noise suppression effect is reduced. However, since the current noise suppression element has no change in appearance, it is not possible to determine under how much high temperature and how much long time the noise suppression element has been used. Therefore, it is difficult to determine the degree of deterioration of the product.

### BRIEF DESCRIPTION OF DRAWINGS

FIG. 1 is a perspective view illustrating a hollow container for a magnetic component according to a first embodiment.

FIG. 2 is a cross-sectional view illustrating a structure of the magnetic component according to the first embodiment.

FIG. 3 is a cross-sectional view illustrating a structure of a magnetic component according to a second embodiment before lid portions are bent.

FIG. 4 is a cross-sectional view illustrating the structure of the magnetic component according to the second embodiment after the lid portions are bent.

FIG. 5 is a perspective view illustrating a structure of a lead-insertion-type magnetic component according to a third embodiment.

FIG. 6 is a perspective view illustrating a rectangular parallelepiped hollow container according to a fourth embodiment before lid portions are bent.

FIG. 7 is a perspective view illustrating the rectangular parallelepiped hollow container according to the fourth embodiment after the lid portions are bent.

FIG. 8 is a perspective view illustrating a structure of a flat-lead-insertion-type magnetic component according to a fifth embodiment.

FIG. 9 is a perspective view illustrating a structure of a lead-wound-type magnetic component according to a fifth embodiment.

### DETAILED DESCRIPTION

A magnetic component of an embodiment includes a hollow container that houses a doughnut-shaped magnetic core, and is made of resin. The hollow container includes an inner wall portion formed in such a manner as to form a hollow portion, an outer wall portion formed in such a manner as to surround the inner wall portion, and a bottom portion provided at one end of each of the inner wall portion and the outer wall portion in such a manner as to close a space between the inner wall portion and the outer wall portion. A color of the resin forming the hollow container exhibits a hue in which a chromatic value C is 0 (achromatic) to 2 and a lightness V is higher than or equal to 8 as defined by JIS Z8721 “Color specification—Specification according to their three attributes”.

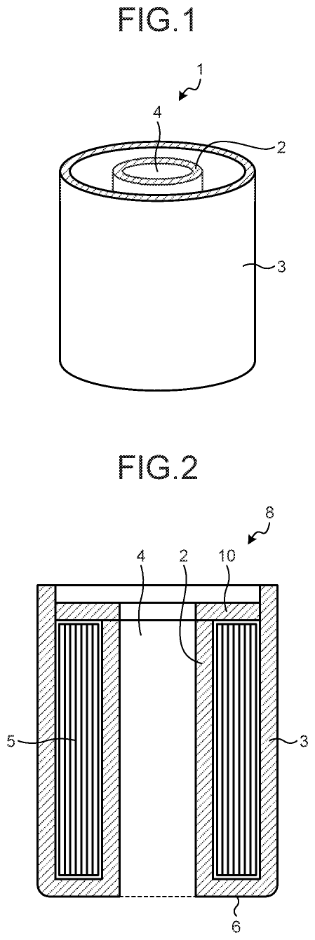

Hereinafter, embodiments for carrying out the present invention will be described. FIG. 1 is a perspective view illustrating a hollow container 1 for a magnetic component 8 according to an embodiment.

The hollow container 1 illustrated in FIG. 1 houses a conductive doughnut-shaped magnetic core 5 between an inner wall portion 2 and an outer wall portion 3 thereof to form the magnetic component 8.

The doughnut-shaped magnetic core 5 is not particularly limited as long as a soft magnetic body having a hollow shape is used. As the soft magnetic body constituting the doughnut-shaped magnetic core 5, ferrite, permalloy, an amorphous magnetic alloy, an Fe-based magnetic alloy having microcrystals, or the like is applied. In addition, various forms of doughnut-shaped magnetic core 5 such as a wound body or a laminated body of a soft magnetic alloy ribbon, a sintered body of soft magnetic alloy powder, and soft magnetic alloy powder solidified with a resin are applicable as the doughnut-shaped magnetic core 5. A soft magnetic body having a hollow shape is referred to as the doughnut-shaped magnetic core, and the doughnut-shaped magnetic core housed in the hollow container is referred to as the magnetic component.

The soft magnetic body constituting the doughnut-shaped magnetic core 5 is more preferably a Co-based amorphous magnetic alloy, an Fe-based amorphous magnetic alloy, an Fe-based magnetic alloy having microcrystals, or the like. These alloys are suitable as a constituent material of the doughnut-shaped magnetic core 5 since it is easy to obtain a magnetic alloy ribbon having a thickness less than or equal to 30 μm. The doughnut-shaped magnetic core 5 can be easily manufactured by winding or laminating the magnetic alloy ribbon.

The amorphous alloy constituting the doughnut-shaped magnetic core 5 preferably has a composition represented by the following Formula (1).

$$\begin{matrix}General Formula & \\ {( {T}_{1} {-}_{a} {M}_{a} )}_{100} {-}_{b} {X}_{b} & ( 1 )\end{matrix}$$

(where T denotes at least one element selected from Fe and Co, M denotes at least one element selected from Ti, V, Cr, Mn, Ni, Cu, Zr, Nb, Mo, Ta, and W, X denotes at least one element selected from B, Si, C, and P, and a and b are values satisfying 0≤a≤0.5 and 10≤b≤35 at %.)

The composition ratio of the element T is adjusted depending on required magnetic characteristics such as a magnetic flux density or an iron loss. In a case where the amount of Fe is large, the element T is an Fe-based amorphous magnetic alloy. In a case where the amount of Co is large, the element T is a Co-based amorphous magnetic alloy. The element M is added for controlling the thermal stability, the corrosion resistance, and the crystallization temperature. The element M is more preferably at least one selected from Cr, Mn, Zr, Nb, and Mo. In a case where the content of the element M is too large, the amount of the element T relatively decreases, which decreases the magnetic characteristics of the amorphous magnetic alloy ribbon, and thus the value of a indicating the content of the element M is set to less than or equal to 0.5. Practically, the thickness is preferably greater than or equal to 0.01.

The element X is an essential element for obtaining an amorphous alloy. In particular, B (boron) is an element effective for amorphization of the magnetic alloy. Si is an element that assists formation of an amorphous phase or is effective for increasing the crystallization temperature. In a case where the addition amount of the element X is too large, a decrease in the magnetic permeability or brittleness occurs. In a case where the addition amount of the element X is too small, amorphization of the magnetic alloy is difficult. Therefore, the content b of the element X is preferably in the range of 10≤b≤35 at %.

Furthermore, as the magnetic alloy ribbon constituting the doughnut-shaped magnetic core 5, it is preferable to use a Co-based amorphous alloy ribbon having excellent saturable characteristics. By using the Co-based amorphous alloy ribbon, the magnetic characteristics of the doughnut-shaped magnetic core 5 can be improved. The Co-based amorphous alloy ribbon preferably has a composition represented by the following Formula (2).

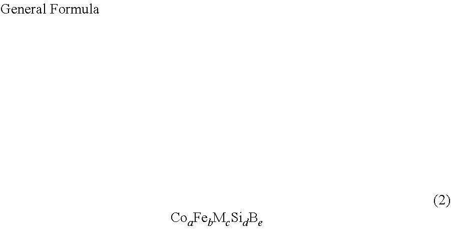

(where a+b+c+d+e=100 at %, 3 b 7 at %, 0.5≤c≤3 at %, 9≤d≤18 at %, and 7≤e≤16 at %.)

In Formula (2), the element M is preferably at least one selected from Nb, Cr, W, Mo, and Ta. By containing such an element M as an essential component, the heat resistance of the Co-based amorphous alloy ribbon is improved. By improving the heat resistance of the Co-based amorphous alloy ribbon, it becomes possible to suppress deterioration of the magnetic characteristics of the doughnut-shaped magnetic core 5 due to a drying step described later. The element M is more preferably Nb. Nb contributes particularly to improvement of heat resistance of the Co-based amorphous alloy ribbon.

The amorphous alloy ribbon used as the magnetic alloy ribbon is preferably manufactured by applying a liquid quenching method. Specifically, the amorphous alloy ribbon is obtained by rapidly cooling, from a molten state, an alloy material prepared at a predetermined composition ratio at a cooling rate faster than or equal to 10⁵° C./sec. The amorphous alloy produced by the liquid quenching method has a ribbon shape. The thickness of the amorphous alloy ribbon is preferably less than or equal to 30 μm, and more preferably 8 to 20 μm. By controlling the thickness of the magnetic thin body, it becomes possible to obtain a low-loss magnetic core.

The Fe-based magnetic alloy having microcrystals preferably has a composition represented by the following Formula (3).

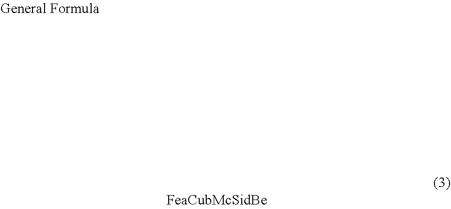

(where M denotes at least one element selected from the group 4a elements, the group 5a elements, the group 6a elements, Mn, Ni, Co, and Al in the periodic table, and a+b+c+d+e=100 at %, 0.01≤b≤4 at %, 0.01≤c≤10 at %, 10≤d≤25 at %, 3≤e≤12 at %, and 17≤d+e≤30 at %.)

Note that the group 4a elements, the group 5a elements, and the group 6a elements in the periodic table are based on the periodic table in Japan.

In the composition of Formula (3), Cu is an element effective for enhancing corrosion resistance, preventing coarsening of crystal grains, and improving soft magnetic characteristics such as an iron loss or the magnetic permeability. The element M is effective for homogenization of crystal grains, reduction of magnetostriction or magnetic anisotropy, and improvement of magnetic characteristics against a temperature change. The magnetic alloy having microcrystals preferably has microcrystals in which crystal grains having a grain diameter of 5 to 30 nm are present in the alloy at an area ratio of greater than or equal to 50%, preferably greater than or equal to 90%.

The Fe-based magnetic alloy ribbon having microcrystals is manufactured, for example, as follows. First, the amorphous alloy ribbon having the alloy composition of Formula (3) is manufactured by a liquid quenching method, and then this amorphous alloy ribbon is subjected to heat treatment at −50 to +120° C. with respect to the crystallization temperature for 1 minute to 5 hours to let microcrystals to be deposited. Alternatively, the rapid cooling temperature at the time of manufacturing the alloy ribbon by the liquid quenching method is controlled to let microcrystals to be directly deposited. Similarly to the amorphous alloy ribbon, the thickness of the magnetic alloy ribbon is preferably less than or equal to 30 μm, and more preferably 8 to 20 μm.

The magnetic alloy ribbon as described above is wound to produce a wound body. Alternatively, the magnetic alloy ribbon is laminated to produce a laminated body. The number of times of winding or the number of laminated layers is set depending on required magnetic characteristics as appropriate. If necessary, an insulating layer may be provided on a surface of the magnetic alloy ribbon. The wound body is obtained by winding the magnetic alloy ribbon in such a manner that a hollow portion is formed at the central portion thereof. By winding the magnetic alloy ribbon, it is possible to obtain a magnetic core having a hollow portion at the central portion thereof, namely, a doughnut-shaped magnetic core 5 (see FIG. 2).

The magnetic alloy ribbon is laminated in such a manner that a hollow portion is formed at the central portion of the laminated body. For example, the magnetic alloy ribbon is cut at a predetermined length to produce magnetic alloy ribbons, and a hole is made in the central portions of the magnetic alloy ribbons. By laminating such magnetic alloy flakes, a magnetic core having a hollow portion in the central portion is formed. That is, the doughnut-shaped magnetic core 5 can be obtained.

The doughnut-shaped magnetic core 5 is housed in the hollow container 1. The hollow container 1 has the inner wall portion 2, having a cylindrical shape, formed in such a manner as to form the hollow portion 4 inside and the outer wall portion 3 disposed in such a manner as to surround the inner wall portion 2. A bottom portion is provided at one end of each of the cylindrical inner wall portion and the outer wall portion in such a manner as to close a space therebetween. The other ends of the cylindrical inner wall portion 2 and the outer wall portion 3 are open portions that are open. The doughnut-shaped magnetic core 5 is inserted from the open portion and housed between the cylindrical inner wall portion 2 and the outer wall portion 3.

The hollow container 1 is preferably formed of an insulating material, and the wall thickness of each of the portions is preferably in a range of 0.05 to 1 mm, more preferably in a range of 0.1 to 0.5 mm. The hollow container 1 is desirably integrally molded by mold molding or the like. It is desirable that the cylindrical inner wall portion 2, the outer wall portion 3, and the bottom portion 6 (see FIG. 2) have an integrated shape.

The magnetic component 8 in FIG. 2 obtained as described above may be used in a high-temperature environment for a long time due to heat generation in a circuit by being incorporated in an electric circuit such as a power supply as a noise suppression element. In such a case, the magnetic characteristics of the noise suppression element tend to be deteriorated and the noise suppression effect tends to be deteriorated, and knowing the use time in the high-temperature environment leads to knowing the deterioration of the magnetic characteristics of the magnetic component. Meanwhile, the hollow container 1, made of resin, of the magnetic component 8 is also subjected to the high-temperature environment, and accordingly, discoloration of the resin occurs.

As for the resin used for the hollow container 1, the resin can be colored for use, and various colors such as blue and black can be used. However, in such a color, the degree of discoloration of the resin is small even when used in the high-temperature environment. Therefore, deterioration in the magnetic characteristics of the magnetic component cannot be determined from the appearance either. By setting the color to one having a chromatic value C of 0 (achromatic) to 2 and a lightness V of 8 to 10 according to JIS Z8721 “Color specification—Specification according to their three attributes”, it becomes easy to determine the degree of discoloration of the resin depending on the time in the high-temperature environment, and it also becomes easy to determine deterioration in the magnetic characteristics of the magnetic component from the appearance.

The degree of discoloration is easily determined in a case where the initial color of the resin is a color having the chromatic value C of 0 to 2 and the lightness V of 8 to 10. In addition, in order to further facilitate the determination of the degree of discoloration, the initial color of the resin preferably has the chromatic value C of less than or equal to 1 and the lightness V of higher than or equal to 9.

In addition, the material of the resin is formed of an insulating resin such as polyethylene terephthalate (PET) or liquid crystal polymer (LCP), for example; however, in order to easily determine the degree of discoloration, it is more preferable to use a polyamide (PA) resin having a large degree of discoloration.

The magnetic component 8 of the first embodiment is manufactured by inserting the doughnut-shaped magnetic core 5 from the open portion of the hollow container 1, housing the doughnut-shaped magnetic core 5 in the hollow container 1, and further attaching a lid portion. In a case where the doughnut-shaped magnetic core 5 is not fixed in the hollow container 1 and moves in the container, the doughnut-shaped magnetic core 5 is fixed with an adhesive agent or the like. As illustrated in FIG. 2, the lid portion 10 is inserted into and fixed to the open portion of the hollow container 1. An adhesive agent is used for the fixing. In order to fix the lid portion 10, in addition to using the adhesive agent, a lid-fixing protrusion may be provided such that the lid is not removed after the lid is placed on the hollow container 1 side.

Instead of using the lid portion 10, an adhesive agent may be poured to form a lid portion and also to fix the doughnut-shaped magnetic core 5. As the adhesive agent, an acrylic-modified silicone resin adhesive agent, an epoxy resin adhesive agent, a phenol resin adhesive agent, or the like can be used. In addition, a lead may be passed through the hollow portion before the adhesive agent is poured therein, a lead portion may be fixed at the same time as the lid portion is formed by the adhesive agent. An adhesive agent portion preferably enters a gap between the doughnut-shaped magnetic core 5 and the hollow container 1 and a gap between the hollow container 1 and the lead portion from the open portion side of the hollow container 1 in a range of 5% to 50% on average with respect to the thickness of the doughnut-shaped magnetic core 5.

Alternatively, the outer wall portion 3 or the inner wall portion 2 of the hollow container 1 may have an extended portion in the height direction with respect to the inserted doughnut-shaped magnetic core 5, and at least one of them may be bent to form the lid portion.

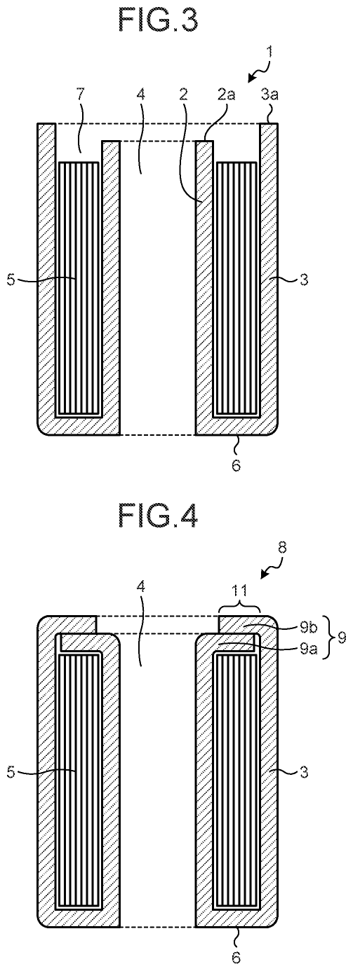

As illustrated in FIG. 3, a hollow container 1 of a magnetic component 8 of a second embodiment has extended portions in which an inner wall portion 2 and an outer wall portion 3 exceed the height of a doughnut-shaped magnetic core 5 when the doughnut-shaped magnetic core 5 is housed from an open portion 7.

As illustrated in FIG. 4, an extended portion 2a and an extended portion 3a are subjected to a bending step described later to form bent portions 9a and 9b, which serve as a lid portion of the magnetic component 8. Alternatively, the lid portion can also be formed by one of the inner wall portion and the outer wall portion by further extending the extended portion 2a and bringing the bent portion 9a into close contact with the extended portion 3a of the outer wall, or conversely, by further extending the extended portion 3a and bringing the bent portion 9b into close contact with the extended portion 2b of the inner wall.

In forming the bent portions 9a and 9b by bending the extended portions 2a and 3a of the inner wall portion 2 and the outer wall portion 3, it is preferable to apply a method of bending the extended portions 2a and 3a by pressing a heated metal head or the like against the extended portions 2a and 3a, which can improve mass productivity of the magnetic component 8. Therefore, it is preferable that the hollow container 1 has a characteristic that allows bending at a predetermined temperature without causing a crack or the like. A wall thickness t of the hollow container 1 is not particularly limited but is preferably in the range of 0.1 to 0.5 mm in consideration of workability and strength. In a case where the wall thickness is less than 0.1 mm, the strength of the hollow container 1 decreases, and furthermore, it is difficult for the resin to spread when molding is performed with a mold, which requires molding to be performed at a high temperature. In a case where the wall thickness of the hollow container 1 exceeds 0.5 mm, the strength increases; however, the volume becomes larger than necessary, which makes it difficult for the hollow container 1 to be downsized.

In this case, there is a possibility that the magnetic component 8 cannot be inserted into a lead of a semiconductor element or the like. The wall thickness of the hollow container 1 is preferably uniform and within the range of 0.1 to 0.5 mm for all the wall thicknesses of the inner wall portion 2, the outer wall portion 3, and the bottom portion 6.

As illustrated in FIG. 4, the magnetic component 8 according to the second embodiment includes a first bent portion 9a formed by bending the extended portion 2a of the inner wall portion 2 towards the outer wall portion 3 and a second bent portion 9b formed by bending the extended portion 3a of the outer wall portion 3 towards the inner wall portion 2. The first and second bent portions 9a and 9b are formed in such a manner as to cover the open portion 7 of the hollow container 1 and substantially serve as a lid portion 9 of the hollow container 1. Since the lid portion 9 includes the first and second bent portions 9a and 9b, no such failure occurs as that the doughnut-shaped magnetic core 5 falls out of the hollow container 1.

The magnetic component 8 illustrated in FIG. 4 includes the lid portion 9 formed by bending the extended portion 2a of the inner wall portion 2 and the extended portion 3a of the outer wall portion 3 in such a manner that the first bent portion 9a is positioned below the second bent portion 9b (on the inner side with respect to the second bent portion 9b). The structure of the lid portion 9 is not limited to this. The lid portion 9 may be formed by bending the extended portion 2a of the inner wall portion 2 and the extended portion 3a of the outer wall portion 3 in such a manner that the second bent portion 9b is positioned below the first bent portion 9a (on the inner side with respect to the first bent portion 9a).

In the magnetic component 8 according to the second embodiment, the first bent portion 9a and the second bent portion 9b preferably overlap with each other. The magnetic component 8 includes an overlapping portion 11 where the first bent portion 9a and the second bent portion 9b overlap with each other. Since there is no gap generated by providing the overlapping portion 11, the function of the lid portion 9 is improved. Therefore, it is possible to prevent occurrence of a failure such as falling off of the doughnut-shaped magnetic core 5 more reliably. For this reason, since fixing with an adhesive agent is unnecessary, the weight can be reduced, and no protrusion defect of an adhesive agent occurs. Since the manufacturing steps can be simplified, the lead time can be shortened.

The magnetic component 8 of the second embodiment described above is manufactured, for example, as follows. First, the hollow container 1, formed of a resin, having the extended portion 2a of the inner wall portion 2 and the extended portion 3a of the outer wall portion 3 is prepared, and the doughnut-shaped magnetic core 5 is housed in the hollow container 1.

Next, by pressing a heated metal head against the extended portion 2a of the inner wall portion 2 and the extended portion 3a of the outer wall portion 3, the extended portion 2a of the inner wall portion 2 is bent towards the outer wall portion 3 to form the first bent portion 9a, and the extended portion 3a of the outer wall portion 3 is bent towards the inner wall portion 2 to form the second bent portion 9b. In this manner, the open portion of the hollow container 1 is covered with the lid portion 9 including the first bent portion 9a and the second bent portion 9b.

By using the heated metal head, the extended portions 2a and 3a of the inner wall portion 2 and the outer wall portion 3 can be bent well. The metal head is preferably heated to a temperature in a range from a temperature (Mp (° C.)) 20% lower than the melting point (Mp (° C.)) of the resin constituting the hollow container 1 (Mp−0.2 Mp=0.8 Mp (° C.)) to the melting point (Mp (° C.)). The heating temperature of the metal head is more preferably not less than a temperature 15% lower than the melting point (Mp (° C.)) of the resin (0.85 Mp (° C.)) and not more than a temperature 5% lower than the melting point (Mp (° C.)) (0.95 Mp (° C.)). A specific heating temperature varies depending on the constituent material of the hollow container 1; however, it is preferably in a range of 100 to 300° C., and more preferably in a range of 160 to 240° C.

In a case where the heating temperature of the metal head is less than 0.8 Mp (° C.), the extended portions 2a and 3a of the inner wall portion 2 and the outer wall portion 3 cannot be bent well. If the heating temperature of the metal head exceeds Mp (° C.), the resin forming the hollow container 1 may be altered and melt. In this case, the shapes of the bent portions 9a and 9b cannot be maintained, and the doughnut-shaped magnetic core 5 is exposed, thereby impairing the function as an insulating exterior. Furthermore, if the temperature of the metal head is too high, the doughnut-shaped magnetic core 5 may be adversely affected. For example, in a case where the amorphous alloy ribbon is used as the constituent material of the doughnut-shaped magnetic core 5, there is a possibility that the coercive force or squareness ratio characteristics are deteriorated by heat.

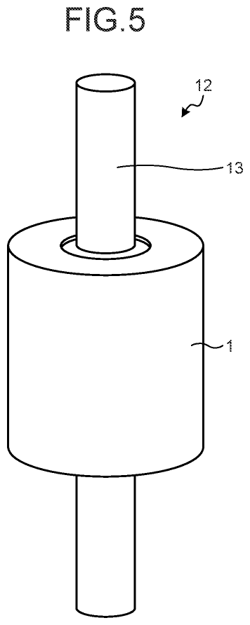

As a third embodiment, illustrated in FIG. 5 is a lead-insertion-type magnetic component 12 in which a lead wire 13 is disposed in a hollow portion at the center of the magnetic component 8 of the second embodiment. The lead wire 13 does not need to have a linear shape and may be bent depending on a mounting mode on a substrate.

### EXAMPLES

Next, magnetic components of examples will be described.

As a method for determining the discoloration of magnetic portions of the examples, it is also effective to determine the discoloration by brightness according to the ISO brightness (JIS P8148) measurement method. As Example 1, a magnetic component sample, obtained by inserting a doughnut-shaped wound body of an amorphous ribbon mainly composed of Co into a white hollow container 1 made of a polyamide resin, was heated to 120° C. for 1000 H, and after each elapsed time, the ISO brightness and the compressive strength were measured at a normal temperature (25° C.). The compressive strength is obtained by applying a load to the magnetic component and measuring the load at the time of breakage. As Example 2, the magnetic component sample having the same structure as that of Example 1 was heated to 140° C. for 1000 H, and after each elapsed time, the brightness and the compressive strength were measured at the normal temperature (25° C.). Furthermore, as Comparative Example 1, the hollow container was made of a commonly used white PBT resin, which was heated to 140° C. for 1000 H, and after each elapsed time, the brightness and the compressive strength were measured at the normal temperature (25° C.). In addition, as Comparative Example 2, measurements were made using a blue PBT resin in a similar manner. These results are shown in Table 1. In Table 1,
Change Difference (%):
Lower limit: brightness (N)Min-brightness (0H)Max
Upper limit: brightness (N)Max-brightness (0H)Min
where N is elapsed time (where change difference ≤0).

From these results, it can be seen that the ISO brightness fluctuates with time at a temperature higher than or equal to 120° C. at which it is known that the characteristic degradation of elements appears. At 120° C., the ISO brightness after a lapse of 1000 H was less than or equal to 20% with respect to the initial value (0 H) of an ISO brightness of 85 to 90% and decreased by more than or equal to 60% as a difference of the ISO brightness percentage. From this, by measuring the ISO brightness of the insulating case, it is possible to estimate about how much high temperature the insulating case has been exposed to for about how many hours.

By acquiring the correlation between the fluctuation of the brightness and the characteristic fluctuation of the element in advance, the timing of replacement of the element can be determined from the ISO brightness.

On the other hand, in Comparative Example 1, discoloration hardly occurred. In Comparative Example 2, it was difficult to see the state of discoloration, and both results were unsuitable for determining an elapsed time from discoloration.

TABLE 1

| | TEMPER- | | ELAPSED TIME [H] | | | |
|---|---|---|---|---|---|---|
| | ATURE | ITEM | 0 H | 96 H | 500 H | 1000 H |
| EXAMPLE 1 | 120° C. | BRIGHTNESS [%] | 85 TO 90 | 50 TO 60 | 25 TO 35 | LESS THAN OR |
| | | | | | | EQUAL TO 25 |
| | | CHANGE | — | −40 TO −25 | −65 TO −50 | ≤−60 |
| | | DIFFERENCE [%] | | | | |
| | | COMPRESSIVE | 60 | 47 | 25 | 20 |
| | | STRENGTH [N] | | | | |
| EXAMPLE 2 | 140° C. | BRIGHTNESS [%] | 85 TO 90 | 40 TO 50 | 20 TO 30 | LESS THAN OR |
| | | | | | | EQUAL TO 15 |
| | | CHANGE | — | −50 TO −35 | −70 TO −55 | ≤−70 |
| | | DIFFERENCE [%] | | | | |
| | | COMPRESSIVE | 60 | 41 | 24 | 18 |
| | | STRENGTH [N] | | | | |
| COMPARATIVE | 140° C. | BRIGHTNESS [%] | 85 TO 90 | 85 TO 90 | 85 TO 80 | 75 TO 80 |
| EXAMPLE 1 | | CHANGE | — | −5 TO 0 | −10 TO −5 | −15 TO −5 |
| | | DIFFERENCE [%] | | | | |
| | | COMPRESSIVE | 55 | 40 | 23 | 19 |
| | | STRENGTH [N] | | | | |
| COMPARATIVE | 140° C. | BRIGHTNESS [%] | 15 TO 20 | 15 TO 20 | 15 TO 20 | 15 TO 20 |
| EXAMPLE 2 | | CHANGE | — | −5 TO 0 | −5 TO 0 | −5 TO 0 |
| | | DIFFERENCE [%] | | | | |
| | | COMPRESSIVE | 55 | 39 | 21 | 18 |
| | | STRENGTH [N] | | | | |

In Examples 1 and 2, the fluctuation in the ISO brightness (JIS P8148) was used as the index; however, fluctuation amounts of the hue, the lightness, and the chromatic value according to JIS Z8721 “Color specification—Specification according to their three attributes” or fluctuation amounts of the tristimulus value Y and values of the chromaticity coordinates x and y indicated as the references thereof may be used. Further alternatively, evaluation can be performed by the color specification according to the XYZ system specified in JIS Z8701 or numerical change amounts in the L*a*b* color space, the L*u*v*color space, or the like, which are specifications of an object color specified in JIS Z8729 converted from numerical values thereof, and the evaluation can be used as an index.

In addition, if a color sample is prepared, an elapsed time can be determined by comparing the color sample with the color of the product. Furthermore, in a case where the color fluctuation is large, it can be visually determined, and thus it is possible to visually determine the replacement time of the magnetic component within a use limit.

As Example 3 in the second embodiment, a doughnut-shaped magnetic core 5 was prepared by winding a Fe-based amorphous metal ribbon containing 1 at % of Cu and having a width of 3 mm into a ring shape to form a shape having an outer diameter ϕ3 and an inner diameter ϕ2 and micro-crystallizing the wound body by heat treatment. As a material of the resin-made hollow container 1 to store, Zytel manufactured by DuPont, which is a polyamide resin, was used. As illustrated in FIG. 1, the hollow container 1 was prepared by injection molding to have a shape having an opening. After the doughnut-shaped magnetic core 5 was inserted into the hollow container 1 made of resin, a metal head heated to the melting point of the resin×0.9° C. was pressed against the extended portion 2a of the inner wall portion 2 and the extended portion 3a of the outer wall portion 3, whereby the extended portion 2a of the inner wall portion 2 was bent towards the outer wall portion 3, and the extended portion 3a of the outer wall portion 3 was closed towards the inner wall 2, whereby the magnetic component 8 illustrated in FIG. 4 was obtained.

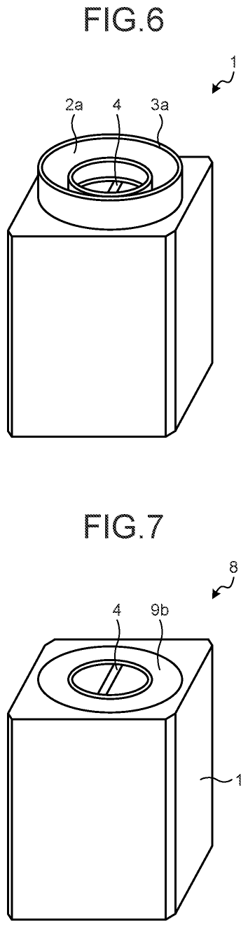

As Example 4 in a fourth embodiment, as illustrated in FIG. 6, a hollow container 1 for housing a doughnut-shaped magnetic core 5 was made of the same material as that in Example 3, the outermost shape was a rectangular parallelepiped shape, a ring-shaped groove was provided at a place for housing the doughnut-shaped magnetic core 5, and extended portions were provided to an inner wall 2 and an outer wall 3. A rectangular hollow portion 4 into which a rectangular lead is inserted is formed at the center of the hollow container 1. After the doughnut-shaped magnetic core 5 was inserted into the hollow container 1, the extended portion 2a of the inner wall and the extended portion 3a of the outer wall were bent in a similar manner to that in Example 3, whereby a magnetic component 8 illustrated in FIG. 7 was obtained.

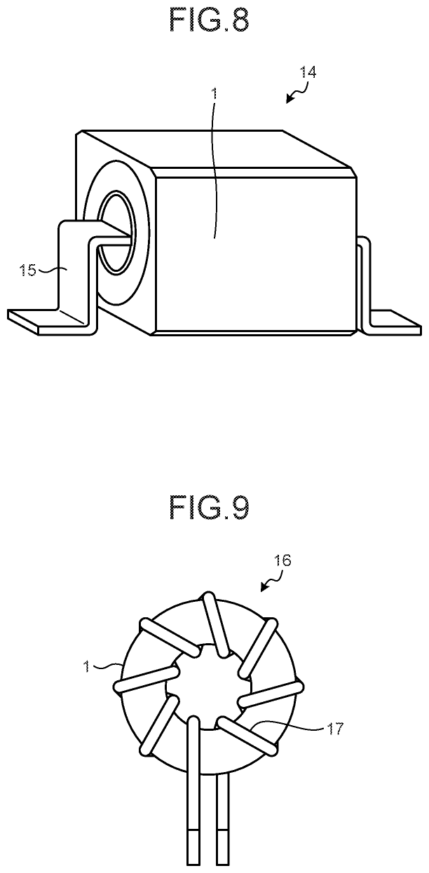

As Example 5 in a fifth embodiment, a flat rectangular lead 15 was inserted into the structure of Example 4 illustrated in FIG. 7, bent portions of the lead serving as soldering terminals at the time of mounting were provided, and a surface mounting type magnetic component 14 illustrated in FIG. 8 was prepared.

Comparative Example 3 was obtained by using a PBT material (DURANEX manufactured by Polyplastics) as the resin material of the hollow container 1 in Example 3.

Comparative Example 4 was obtained by using a liquid crystal resin (Siveras manufactured by Toray Industries, Inc.) as the resin material of the hollow container in Example 3.

For each of the Examples and Comparative Examples, 500 pieces were prepared, and the appearances were compared. Those having a problem as an insulating exterior such as a crack or a chip were regarded as being defective, and the yields were compared. The yield was calculated as (number of good products/number of products (500)×100) [%].

TABLE 2

| | CASE | BENT | SHAPE/ | YIELD |
|---|---|---|---|---|
| | MATERIAL | STRUCTURE | LEAD | [%] |
| EXAMPLE 3 | POLYAMIDE | OUTER AND | RING | 100 |
| | RESIN | INNER | | |
| EXAMPLE 4 | POLYAMIDE | OUTER AND | PARALLEL- | 100 |
| | RESIN | INNER | EPI-PED | |
| EXAMPLE 5 | POLYAMIDE | OUTER AND | PARALLEL- | 99.4 |
| | RESIN | INNER | EPI-PED, | |
| | | | LEAD | |
| COMPARATIVE | PBT RESIN | OUTER AND | RING | 100 |
| EXAMPLE 3 | | INNER | | |
| COMPARATIVE | LIQUID | OUTER AND | RING | 15.8 |
| EXAMPLE 4 | CRYSTAL | INNER | | |
| | RESIN | | | |

In this evaluation, in Comparative Example 3, occurrence of a crack, a chip, or the like was not observed.

In Comparative Example 4, a large number of cracks and chips occurred on the bent side on the inner diameter side.

Exposure to an atmosphere of 260° C.×10 minutes close to reflow conditions was further performed, and the appearances were compared in a similar manner.

TABLE 3

| | APPEARANCE |
|---|---|
| EXAMPLE 3 | NO PROBLEM |
| EXAMPLE 4 | NO PROBLEM |
| EXAMPLE 5 | NO PROBLEM |
| COMPARATIVE | DEFORMED |
| EXAMPLE 3 | |
| COMPARATIVE | NO PROBLEM |
| EXAMPLE 4 | |

The PBT resin of Comparative Example 3 was deformed due to sagging or the like as if melted.

As described above, by using the polyamide resin as the material of the resin-made hollow container 1 used for the magnetic component 8 having a structure in which both or one of the extended portion 2a of the inner wall portion 2 and the extended portion 3a of the outer wall portion 3 are bent to form the lid portion 9, the heat resistance at the reflow temperature, which has been a problem with the PBT resin, is maintained, and defects such as deformation do not occur. In addition, it has been found that no cracks nor chips occur due to stress generated when the extended portion 2a of the inner wall portion 2 or the extended portion 3a of the outer wall portion 3 is bent by caulking by heat, which has been a problem with the liquid crystal resin having a weak weld strength.

As a result, in the magnetic component 5 in which the outermost shape of the container is a rectangular parallelepiped, the flat rectangular lead 15 is passed through the hollow portion 4 in the center, and the bent portions are provided in such a manner as to be the soldering terminals as in Example 5, there is no deformation of the container, and the magnetic component can withstand the reflow temperature, and thus mounting by reflow soldering using an automatic mounter is possible. Alternatively, in FIG. 8, the flat rectangular lead 15 is provided with the soldering terminal portions outside the hollow container 1; however, it is also possible to fold the flat rectangular lead 15 towards the hollow container 1 side to form soldering terminals under one surface to be the bottom surface of the rectangular parallelepiped.

Furthermore, connection portions of surfaces of the outermost rectangular parallelepiped of the container may be chamfered or round-chamfered as long as mechanical stability at the time of suction for conveyance and soldering at the time of automatic mounting is ensured. In addition, the surfaces other than the surfaces to be used for suction and soldering are not limited to being flat as long as conveyance failure does not occur at the time of mounting.

Furthermore, as illustrated in FIG. 9, a lead-wound-type magnetic component 16 of a fifth embodiment in which a lead wire 17 is wound around a doughnut-shaped magnetic component 8 can also be used.

Although several embodiments of the present invention have been described, these embodiments have been presented as examples and are not intended to limit the scope of the invention. These novel embodiments can be implemented in various other forms, and various omissions, substitutions, and modifications can be made without departing from the gist of the invention. These embodiments and modifications thereof are included in the scope and gist of the invention and are included in the invention described in the claims and an equivalent scope thereof.

What is claimed is:

1. A magnetic component comprising
a hollow container that houses a doughnut-shaped magnetic core, the hollow container being made of resin, the hollow container including:
an inner wall portion formed in such a manner as to form a hollow portion;
an outer wall portion formed in such a manner as to surround the inner wall portion; and
a bottom portion provided at one end of each of the inner wall portion and the outer wall portion in such a manner as to close a space between the inner wall portion and the outer wall portion,
wherein a color of the resin forming the hollow container exhibits a hue in which a chromatic value C is 0 (achromatic) to 2 and a lightness V is higher than or equal to 8 as defined by JIS Z8721 “Color specification—Specification according to their three attributes”.

2. The magnetic component according to claim 1,
wherein the color of the resin forming the hollow container exhibits a hue in which the lightness V is higher than or equal to 9.

3. The magnetic component according to claim 1,
wherein the color of the resin forming the hollow container exhibits a hue in which the chromatic value C is less than or equal to 1.

4. The magnetic component according to claim 1,
wherein the hollow container is made of a polyamide resin.

5. The magnetic component according to claim 1,
wherein a change difference in percentage of an ISO brightness (JIS P8148) decreases more than or equal to 60% relative to an initial value of the ISO brightness in percentage determined by the ISO brightness measurement method after exposure to a high temperature of 120° C. for 1000 hours.

6. The magnetic component according to claim 1,
wherein the hollow container has a structure in which at least one of the outer wall portion or the inner wall portion at an end opposite to the bottom portion is bent to form a lid portion.

7. The magnetic component according to claim 1,
wherein the doughnut-shaped magnetic core is obtained by winding a magnetic ribbon.

8. The magnetic component according to claim 1,
wherein the magnetic component has a compressive strength higher than or equal to 50 N at a normal temperature (25° C.).

9. The magnetic component according to claim 1,
wherein a lead is inserted into the hollow portion.

10. The magnetic component according to claim 1,
wherein a lead is inserted into the hollow portion and wound in such a manner as to alternately pass through an inner wall side and an outer wall side of the magnetic component.

11. The magnetic component according to claim 1,
wherein a lead is inserted into the hollow portion, the lead having a rectangular cross section.

12. The magnetic component according to claim 1,
wherein the magnetic component is a noise suppression element.
